(19) United States
(12) Patent Application Publication
(10) Pub. No.: US 2013/0221020 A1
(43) Pub. Date: Aug. 29, 2013

(54) Product Dispensing System with Staged Container Opening

(71) Applicants: Matthew E. Zacherle, Richmond, VA (US); Caleb S. Loftin, Richmond, VA (US)

(72) Inventors: Matthew E. Zacherle, Richmond, VA (US); Caleb S. Loftin, Richmond, VA (US)

(21) Appl. No.: 13/404,159

(22) Filed: Feb. 24, 2012

(51) Int. Cl. B65G 59/00

(52) U.S. Cl. 221/68

(57) ABSTRACT

A product dispensing system including a dispenser frame having a front end longitudinally opposed from a rear end, the dispenser frame including a first support deck extending at least partially between the front end and the rear end along a longitudinal axis, the first support deck defining a guide channel having an entrance passage extending along a passage axis, wherein the passage axis is generally parallel with the longitudinal axis, and a second support deck positioned below the first support deck, the second support deck extending at least partially between the front end and the rear end, and defining a product display area proximate the front end, and a catch element connected to the dispenser frame proximate the guide channel, wherein the entrance passage is at least partially defined by the catch element.

### FIELD

This application relates to the dispensing of products from packaging containers and, more particularly, to product dispensers configured to cooperate with packaging containers to dispense products.

### BACKGROUND

Products are typically shipped to retailers in bulk by enclosing multiple individual product units in a container, such as a carton or box. For example, canned foods may be shipped to a retailer in a box containing a number of individual cans. Then, it is typically the retailer's obligation to remove the individual product units from the container and present them to consumers.

Alternatives to the traditional package-ship-unpack-display model have been developed in an effort to improve operating efficiency. For example, U.S. Pat. No. 7,922,437 to Loftin et al., the entire contents of which are incorporated herein by reference, discloses a new system for dispensing and displaying products packaged in a container. Specifically, the system includes a frame having a support structure, a product display area and an opening tool. The frame may be positioned on a retailer's shelf and loaded with product simply by placing a container comprising multiple units of product onto the support structure of the frame. As the container is being placed onto the support structure, the opening tool of the frame opens the container in such a manner that products roll from the container and down to the product display area of the frame under the force of gravity.

As another example, U.S. patent application Ser. No. 13/032,734 filed by Gelardi et al., the entire contents of which are incorporated herein by reference, discloses a product dispensing system that utilizes an opening tool having a catch element that engages and opens a container as the container is loaded onto the dispenser, and then guides the container to avoid interference between the dispensing products and the open container.

Despite advances already made in the field, those skilled in the art continue with research and development efforts directed to apparatus and systems for dispensing products from packaging containers.

### SUMMARY

In one aspect, the disclosed product dispensing system may include a dispenser frame having a front end longitudinally opposed from a rear end, the dispenser frame including a first support deck extending at least partially between the front end and the rear end along a longitudinal axis, the first support deck defining a guide channel having an entrance passage extending along a passage axis, wherein the passage axis is generally parallel with the longitudinal axis, and a second support deck positioned below the first support deck, the second support deck extending at least partially between the front end and the rear end, and defining a product display area proximate the front end, and a catch element connected to the dispenser frame proximate the guide channel, wherein the entrance passage is at least partially defined by the catch element.

In another aspect, the disclosed product dispensing system may include a dispenser frame having a front end longitudinally opposed from a rear end, the dispenser frame including a first support deck extending at least partially between the front end and the rear end, the first support deck defining a guide channel having an entrance opening and an exit opening, the first support deck further defining a recessed drop zone positioned between the entrance opening and the exit opening, the guide channel being curved such that the entrance opening opens generally towards the recessed drop zone and the exit opening opens generally toward the front end, and a second support deck positioned below the first support deck, the second support deck extending at least partially between the front end and the rear end, and defining a product display area proximate the front end, and a catch element connected to the dispenser frame, the catch element being positioned proximate the entrance opening, protruding toward the front end and extending over at least a portion of the recessed drop zone.

In another aspect, the disclosed product dispensing system may include a dispenser frame having a front end longitudinally opposed from a rear end, the dispenser frame including a first support deck extending at least partially between the front end and the rear end, the first support deck defining a guide channel having an entrance opening and an exit opening, the first support deck further defining a recessed drop zone positioned between the entrance opening and the exit opening, wherein the entrance opening opens generally towards the recessed drop zone and the exit opening opens generally toward the front end, and a second support deck positioned below the first support deck, the second support deck extending at least partially between the front end and the rear end, and defining a product display area proximate the front end, wherein the dispenser frame defines an opening sized to allow product passage from the first support deck down to the second support deck, a catch element connected to the dispenser frame, the catch element being positioned proximate the entrance opening, protruding toward the front end and extending over at least a portion of the recessed drop zone, and a container that defines an internal volume and an access opening into the internal volume, the container being positioned on the upper support deck such that the access opening is aligned with the opening defined by the dispenser frame, wherein a portion of the container extends through the guide channel and is positioned between the first support deck and the second support deck.

In yet another aspect, disclosed is a product dispensing method. The method may include the steps of (1) providing a dispenser having a frame. The frame may contain a front end and a longitudinally opposed rear end. The frame may further contain a first support deck that extends at least partially between the front end and rear ends and further defines a guide channel that has entrance and exit openings and a recessed drop zone between the entrance and exit openings. The entrance opening may open toward the recessed drop zone and the exit opening may open toward the front end. The frame may also contain a second support deck positioned below the first support deck that extends at least partially between the front and rear ends and defines a product display area proximate the front end. The dispenser may further have a catch element positioned proximate the rear end and connected to the frame. The catch element may protrude toward the front end and extend above at least a portion of the recessed drop zone. The dispenser may further contain an access panel guide element positioned proximate the catch element between the first and second support decks, and protruding toward said front end. The access panel guide element may further form an access panel guide channel between the access panel guide element and the first support deck. The method may further include steps of (2) providing a container that initially houses one or more products; (3) forming an initiation opening in the container; (4) urging the container along the first support deck from the front end toward the rear end so that one of the products, when positioned above the recessed drop zone, forces the container downward into the recessed drop zone, and the catch element engages the initiation opening and separates an access panel from the container to form a second opening. The separated access panel may be directed backwards towards the guide channel, then into the guide channel, where it is then redirected in the opposite direction into the access panel guide channel. Finally, the method may also include the step of (5) aligning the second opening with the first opening such that at least one product moves from the container to the product display area, wherein the product contacts the separated access panel as the product moves along the second support deck toward the product display area.

Other aspects of the disclosed product dispensing system with staged container opening will become apparent from the following detailed description, the accompanying drawings and the appended claims.

### BRIEF DESCRIPTION OF THE DRAWINGS

FIG. 1 is a front and side perspective view of one aspect of the disclosed product dispensing system with container-product interaction;

FIG. 2A is a bottom and side perspective view of the container of the product dispensing system of FIG. 1;

FIG. 2B is a bottom and side perspective view of the container of FIG. 2A, shown with an initiation opening formed therein;

FIG. 3 is a side and bottom perspective view of the container of FIG. 2B, shown in an opened configuration;

FIG. 4 is a top plan view of a container blank that may be used to form the container of FIG. 2A;

FIG. 5A is a side elevational view, in section, of the dispenser of the product dispensing system of FIG. 1;

FIG. 5B is a detailed view, in section, of the catch element of the product dispensing system of FIG. 5A;

FIG. 6 is a side elevational view, in section, of the dispenser of FIG. 5A, shown with the container in a partially loaded configuration; and

FIG. 7 is a side elevational view, in section, of the dispenser of FIG. 6, shown with the container in a fully loaded configuration.

### DETAILED DESCRIPTION

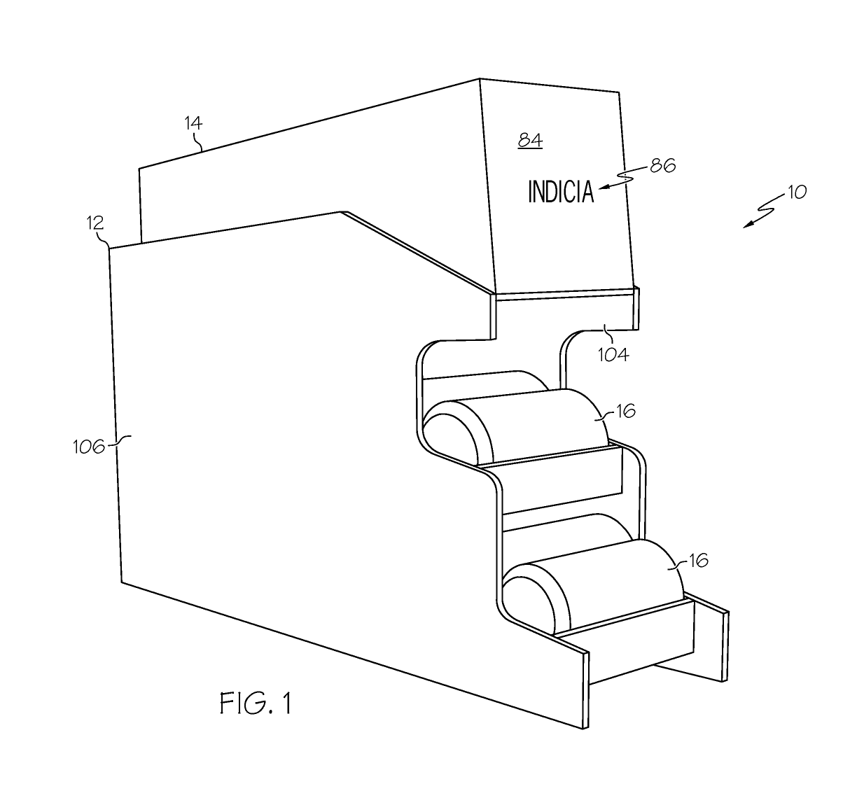

Referring to FIG. 1, one aspect of the disclosed product dispensing system with container-product interaction, generally designated 10, may include a dispenser 12 and a container 14. The container 14 may house multiple units of product 16. The container 14 may be loaded onto the dispenser 12 by urging the container 14 generally horizontally along the dispenser 12. As the container 14 is urged along the dispenser 12, the dispenser 12 may engage and open the container 14, thereby releasing the products 16 from the container 14 to the dispenser 12.

The container 14 may be any container capable of initially housing products 16 and beneficially interacting with the disclosed dispenser 12. For example, the container 14 may be a paperboard carton or a corrugated box.

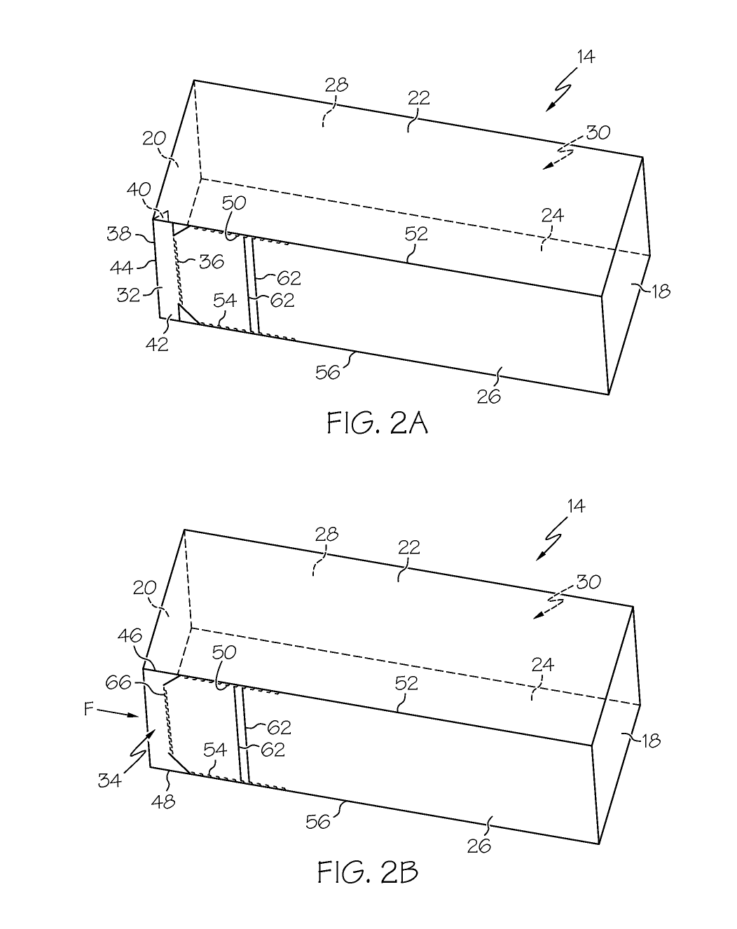

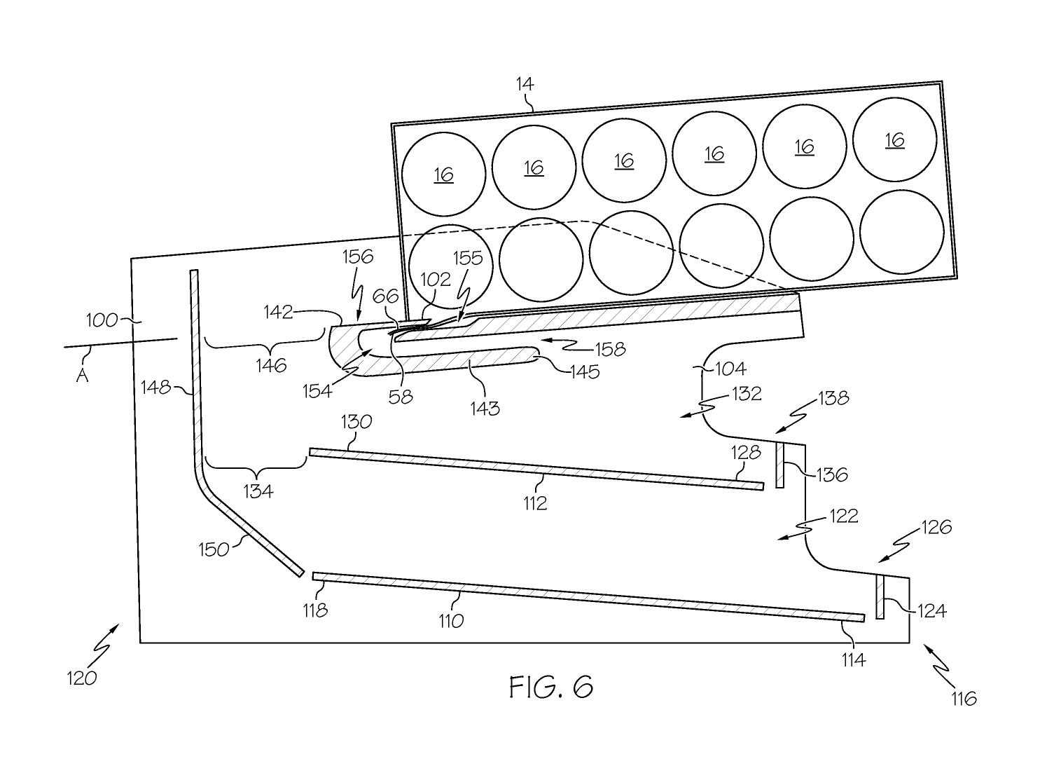

Referring to FIG. 2A, the container 14 may be a generally rectilinear container having six walls 18, 20, 22, 24, 26, 28 that define an internal volume 30 for receiving the products 16, as shown in FIG. 6. Opposed walls 18 and 20 may define the front and rear walls, respectively, of the container 14. Opposed walls 22 and 24 may define the first (e.g., left) and second (e.g., right) side walls, respectively, of the container 14. Opposed walls 26 and 28 may define the base and upper walls, respectively, of the container 14.

In a first construction, the base wall 26 of the container 14 may include a removable priming feature 32, as shown in FIG. 2A. As shown in FIG. 2B, the removable priming feature 32 may be removed from the container 14 to reveal an initiation opening 34 that opens into the internal volume 30 of the container 14. The removable priming feature 32 may be positioned such that the initiation opening 34 is formed proximate (i.e., at or near) the rear wall 20 of the container 14, such as along the edge 44 between the base wall 26 and the rear wall 20.

Referring to FIG. 2A, the removable priming feature 32 may be a zipper strip or the like, and may be defined by two parallel, laterally extending rows of perforations 36, 38 and two parallel, longitudinally extending rows of perforations 40, 42. Weakening features other than perforations may also be used.

Thus, prior to loading the container 14 onto the dispenser 12, a user may remove the removable priming feature 32 from the container 14, such as by tearing the removable priming feature 32 from the container 14 along the rows of perforations 36, 38, 40, 42, thereby forming the initiation opening 34, as shown in FIG. 2B.

In a second construction, the initiation opening 34 may be pre-formed in the base wall 26 of the container 14. Optionally, a peelable label or the like (not shown) may be applied to the container 14 over the pre-formed initiation opening 34. Therefore, the initiation opening 34 may be revealed by peeling away the optional peelable label from the container 14.

Referring to FIG. 2B, the initiation opening 34 may extend generally laterally between the side walls 22, 24 of the container 14. For example, the initiation opening 34 may include a first (e.g., left) end 46 positioned proximate the left side wall 22 of the container 14 and a second (e.g., right) end 48 positioned proximate the right side wall 24 of the container 14.

Those skilled in the art will appreciate that the initiation opening 34 may be positioned at various alternative locations and may have various alternative configurations, provided that the initiation opening 34 is capable of being engaged by the dispenser 12 when the container 14 is being loaded onto the dispenser 12. As a first alternative implementation, the initiation opening 34 may be formed in the rear wall 20 of the container 14. As a second alternative implementation, the initiation opening 34 may be formed in the base wall 26, between the front 18 and rear 20 walls of the container 14. Other implementations are also contemplated.

A first weakening feature 50 may generally longitudinally extend from the initiation opening 34 toward the front wall 18 of the container 14. The first weakening feature 50 may be formed in the base wall 26 proximate the edge 52 between the base wall 26 and the left side wall 22.

A second weakening feature 54 may generally longitudinally extend from the initiation opening 34 toward the front wall 18 of the container 14, and may be laterally spaced from the first weakening feature 50. The second weakening feature 54 may be formed in the base wall 26 proximate the edge 56 between the base wall 26 and the right side wall 24.

The longitudinal length of the first and second weakening features 50, 54 may be dictated by the size (e.g., the diameter) of the products 16 housed in the container 14. As one example, the first and second weakening features 50, 54 may extend along at least 5 percent of the length of the edge 52. As another example, the first and second weakening features 50, 54 may extend along at least 10 percent of the length of the edge 52. As another example, the first and second weakening features 50, 54 may extend along at least 20 percent of the length of the edge 52. As yet another example, the first and second weakening features 50, 54 may extend along at least 30 percent of the length of the edge 52.

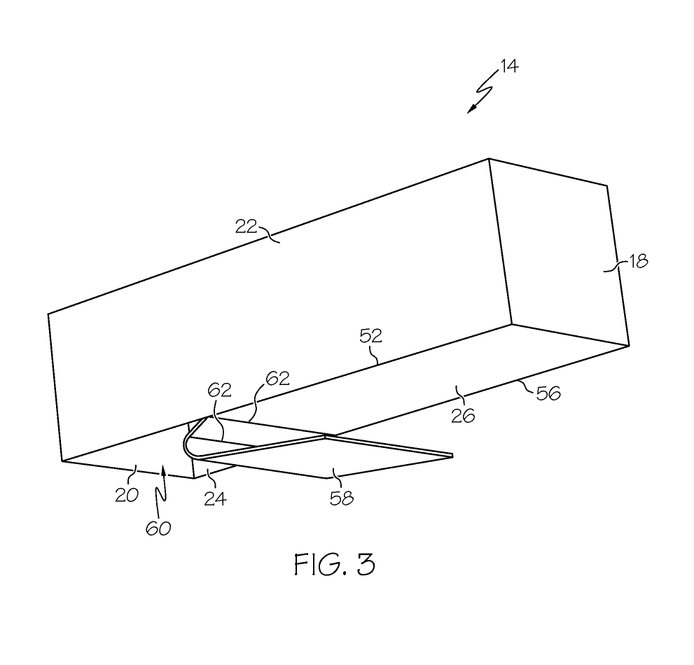

The first and second weakening features 50, 54 may facilitate the separation of a portion of the base wall 26 from the rest of the container 14, as shown in FIG. 3. In a first implementation, the first and second weakening features 50, 54 may be formed as rows of perforations. For example, the first and second weakening features 50, 54 may be formed as rows of standard perforations, as rows of micro perforations or as rows of zipper-like cuts. In a second implementation, the first and second weakening features 50, 54 may be formed by scoring the container 14. In a third implementation, the first and second weakening features 50, 54 may be formed by creasing the container 14. Other techniques useful for forming the first and second weakening features 50, 54 will become apparent to those skilled in the art.

Thus, a force F (FIG. 2B) applied to the base wall 26 at the initiation opening 34 may partially separate a portion of the base wall 26 from the container 14 along the first and second weakening features 50, 54 to form an access panel 58, as shown in FIG. 3. As the access panel 58 is separated from the remainder of the container 14, the size of the initiation opening 34 may be significantly increased, thereby forming an access opening 60 in the container 14. The access opening 60 may allow the products 16 housed in the container 14 to be dispensed from the container 14 and, ultimately, into the dispenser 12 when the container 14 is loaded on the dispenser 12.

Optionally, one or more preformed fold lines 62 may laterally extend across the base wall 26 to encourage the access panel 58 to pivot relative to the base wall 26 of the container 14. Preformed fold lines 62 may reduce or eliminate the possibility that the access panel 58 will randomly fold or bunch-up as the access panel 58 is formed.

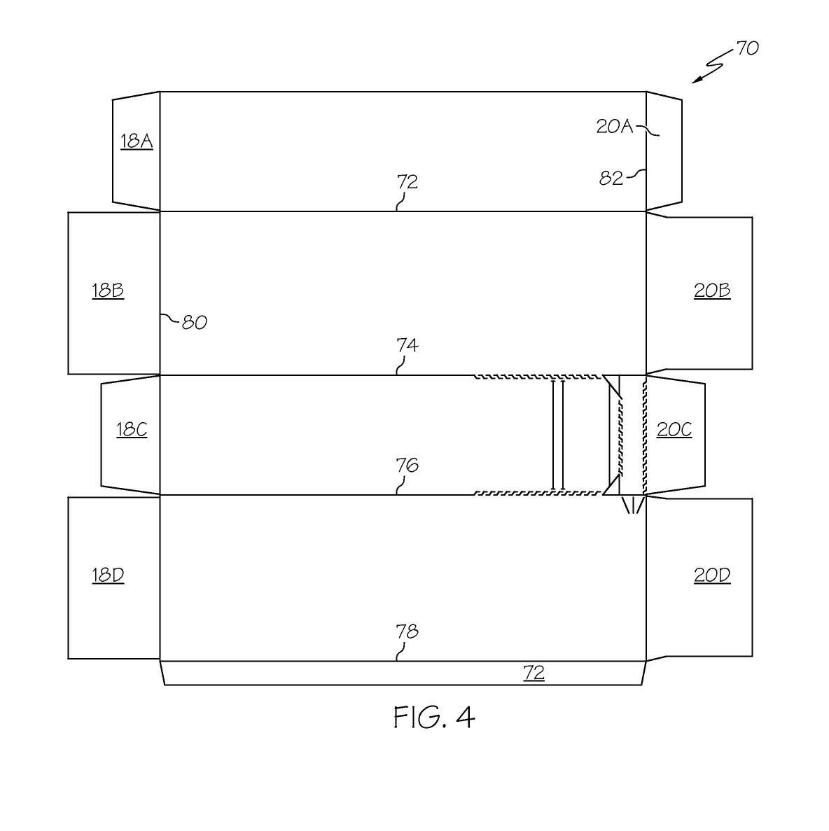

The container 14 may be formed from a paperboard container blank, such as the paperboard container blank 70 shown in FIG. 4. The container blank 70 may include a plurality of pre-formed fold lines 72, 74, 76, 78, 80, 82 that define the front wall 18, the rear wall 20, the right side wall 22, the left side wall 24, the base wall 26, the upper wall 28 and a sealing panel 72.

The container 14 may be assembled by folding the container blank 70 along the longitudinal fold lines 72, 74, 76, 78 and connecting the upper wall 28 to the sealing panel 72 to form the three-dimensional body of the container 14. Then, the front wall panels 18A, 18B, 18C, 18D may be assembled to form the front wall 18 of the container 14. Finally, the rear wall panels 20A, 20B, 20D, 20D may be assembled to form the rear wall 20 of the container 14.

The container blank 70 may be formed from a paperboard-based material, such as C1S paperboard, which may have a coating (e.g., clay) on a first major surface thereof, which may form the outer surface 84 (FIG. 1) of the container 14, and an uncoated second major surface. As another example, the paperboard-based material may be C2S paperboard, which may have a coating (e.g., clay) on both major surfaces thereof Optionally, at least one major surface of the container blank may be marked with various indicia 86 (FIG. 1), such as printed text and/or graphics.

While a specific paperboard container blank 70 is shown and described, those skilled in the art will appreciate that various techniques and materials may be used to form the container 14. Folded paperboard containers are only one specific and non-limiting example of the disclosed container 14.

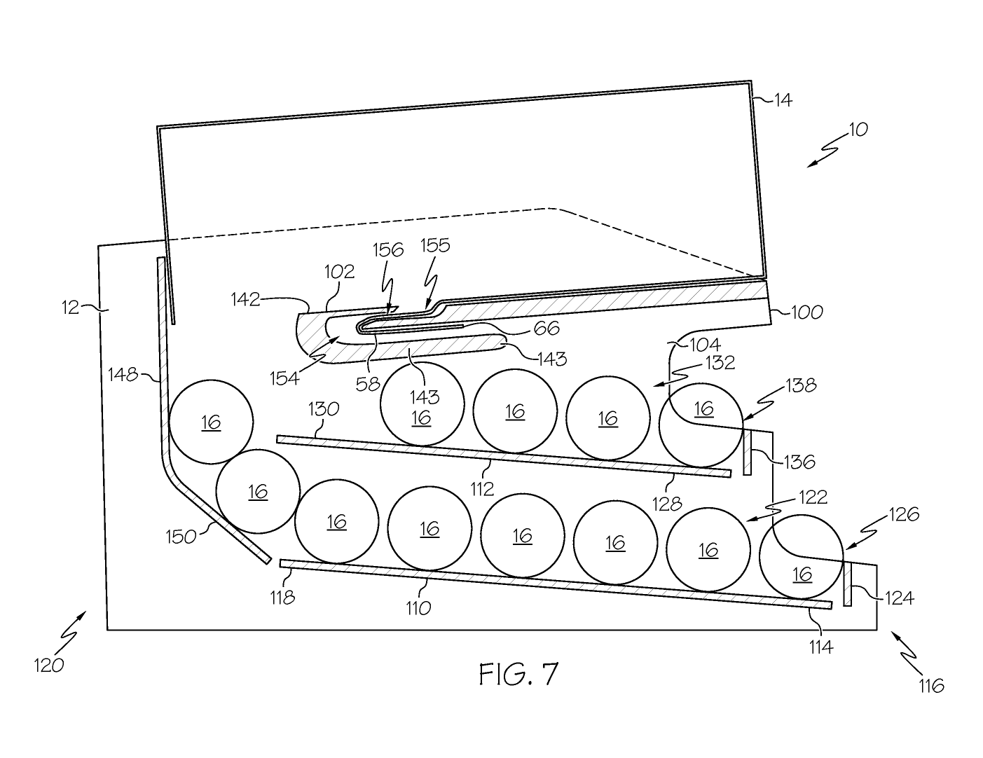

Various products 16 having various shapes and configurations may be initially housed in the container 14, as shown in FIG. 6, and may be dispensed from the container 14 to the dispenser 12, as shown in FIG. 7. Suitable products 16 include cans (e.g., canned soup or pet food), jars (e.g., jarred sauce) or bottles (e.g., bottled soft drinks)

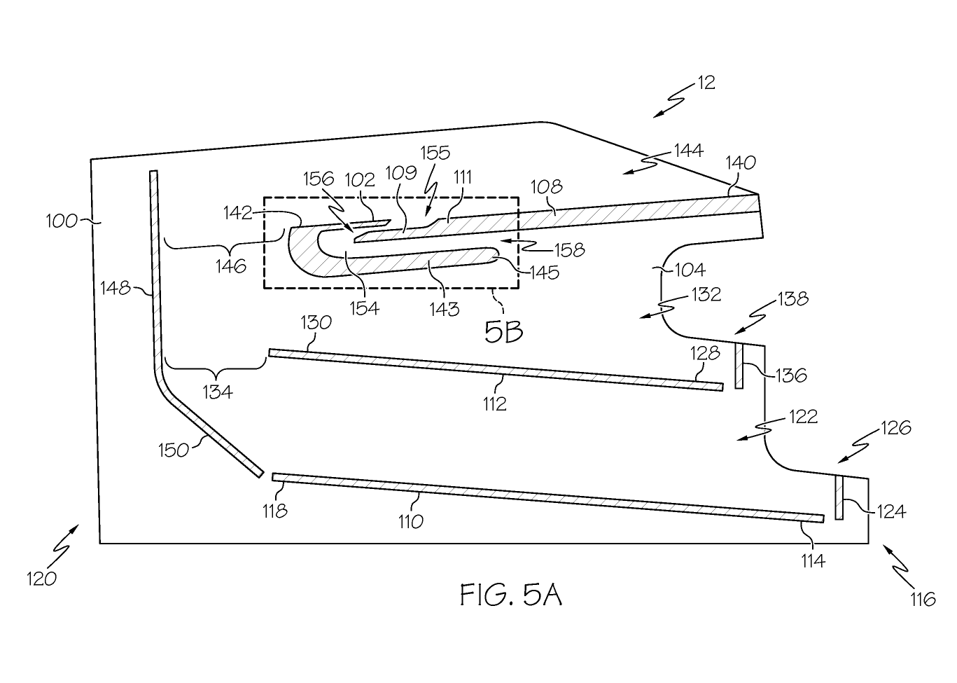

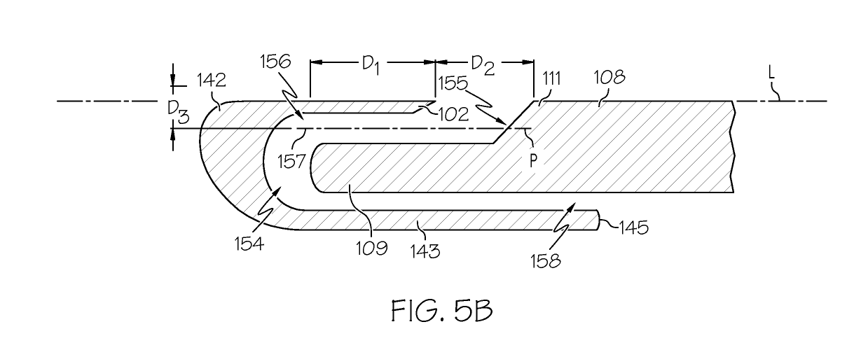

Referring to FIG. 5A, the dispenser 12 may include a frame 100, a catch element 102 and an access panel guide element 143. The frame 100 of the dispenser 12 may support the container 14 in a desired configuration, such as a slightly declined, but generally horizontal configuration, as shown in FIG. 7. As the container 14 is generally horizontally urged along the dispenser 12 to the configuration shown in FIG. 7, the catch element 102 may engage the initiation opening 34 (FIG. 2B) in the container 14 to separate the access panel 58 (FIG. 3) from the container 14, and guide the access panel 58 through a channel 154 defined by the guide element 143, as is described in greater detail herein.

The frame 100 may include a first (e.g., right) side wall 104, a second (e.g., left) side wall 106, an upper support deck 108, a lower support deck 110 and, optionally, one or more intermediate support decks 112 (only one is shown in FIG. 5) positioned between the upper support deck 108 and the lower support deck 110. The right side wall 104 may be laterally spaced from the left side wall 106, and may be generally parallel with the left side wall 106.

The lower support deck 110 may laterally extend between the right and left side walls 104, 106, and may include a front end 114 that longitudinally extends toward the front end 116 of the frame 100 and a rear end 118 that longitudinally extends toward the rear end 120 of the frame 100. Therefore, the lower support deck 110 and the side walls 104, 106 may define a lower level 122 of the frame 100.

The lower support deck 110 may be inclined from the front end 114 to the rear end 118 (i.e., the rear end 118 may be elevated relative to the front end 114) such that products 16 deposited proximate the rear end 118 of the lower support deck 110 roll down to the front end 114 of the lower support deck 110 under the force of gravity.

A stop 124 may be positioned proximate the front end 114 of the lower support deck 110 to prevent products 16 from rolling beyond the front end 114 of the lower support deck 110. Therefore, the stop 124 may collect products 16 at the front end 114 of the lower support deck 110, thereby defining a first product display area 126 proximate the front end 114 of the lower support deck 110.

The intermediate support deck 112 may be positioned between the upper support deck 108 and the lower support deck 110. The intermediate support deck 112 may laterally extend between the right and left side walls 104, 106, and may include a front end 128 that longitudinally extends toward the front end 116 of the frame 100 and a rear end 130 that longitudinally extends toward, but not to, the rear end 120 of the frame 100. Therefore, the intermediate support deck 112 and the side walls 104, 106 may define an intermediate level 132 of the frame 100.

The spacing between the rear end 130 of the intermediate support deck 112 and the rear end 120 of the frame 100 may define an opening 134, which may function as a chute to allow products 16 to move from the intermediate level 132 down to the lower level 122 of the frame 100 under the force of gravity.

The intermediate support deck 112 may be inclined from the front end 128 to the rear end 130 (i.e., the rear end 130 may be elevated relative to the front end 128) such that products 16 deposited proximate the rear end 130 of the intermediate support deck 112 roll down to the front end 128 of the intermediate support deck 112 under the force of gravity.

A stop 136 may be positioned proximate the front end 128 of the intermediate support deck 112 to prevent products 16 from rolling beyond the front end 128 of the intermediate support deck 112. Therefore, the stop 136 may collect products 16 at the front end 128 of the intermediate support deck 112, thereby defining a second product display area 138 proximate the front end 128 of the intermediate support deck 112. The second product display area 138 may be longitudinally displaced (e.g., inwardly) relative to the first product display area 126.

The upper support deck 108 may laterally extend between the right and left side walls 104, 106, and may include a front end 140 that longitudinally extends toward the front end 116 of the frame 100 and a rear end 142 that longitudinally extends toward, but not to, the rear end 120 of the frame 100. Therefore, the upper support deck 108 and the side walls 104, 106 may define an upper level 144 of the frame 100.

The spacing between the rear end 142 of the upper support deck 108 and the rear end 120 of the frame 100 may define an opening 146, which may function as a chute to allow products 16 to move from the upper level 144 down to the intermediate and lower levels 132, 122 of the frame 100 under the force of gravity.

The upper support deck 108 may be declined from the front end 140 to the rear end 142 (i.e., the front end 140 may be elevated relative to the rear end 142). Therefore, products 16 supported on the upper support deck 108 may roll under the force of gravity down toward the rear end 142 of the upper support deck 108, through the opening 146, to the lower and intermediate levels 132, 122 of the frame 100 and, ultimately, to the first and second product display areas 126, 138.

Referring to FIG. 5B, the upper support deck 108 may contain varying areas of thickness, wherein the front end 140 may generally be thicker than a middle portion 109. The thickness defined at the front end 140 may drop a depth D₃ to the thickness defined by the middle portion 109 at a location 111.

The location 111 where the drop in thickness defined by the front end 140 to the thickness defined by the middle portion 109 may generally define a first end 157 of a recessed, pre-engagement drop zone 155. The location of the recessed, pre-engagement drop zone 155 may generally be defined by an area encompassing a distance D₂, which extends from the end of the catch element 102 to the first end 157. The distance D₂ may generally be less than or equal to the diameter of one unit of product 16 (FIG. 6), may be less than or equal to 75% of the diameter of one unit of product 16, or may be less than or equal to 50% of the diameter of one unit of product 16.

In an effort to minimize problems with the catch element 102 improperly catching and/or separating the access panel 58 (as shown in FIG. 6 and described in more detail herein), the size of the recessed, pre-engagement drop zone 155 may allow for a product 16 to partially drop under force of gravity into the recessed, pre-engagement drop zone 155 while still in the container 14. Such a drop may allow for the product 16 to urge the rear edge 66 of the base wall 26 of the container 14 downward so that the rear edge 66 is properly caught by the catch element 102 in a smooth and fluid fashion to allow optimal separation of the access panel 58.

Referring back to FIG. 5A, the frame 100 of the dispenser 12 may further include an optional rear wall 148. The rear wall 148 may function as a stop proximate the rear end 120 of the frame 100, thereby inhibiting rearward horizontal movement of the container 14 along the upper support deck 108 beyond the stop rear wall 148.

A guide 150 may be connected to, or integral with, the rear wall 148. The guide 150 may extend from proximate the opening 146 in the upper level 144 defined by the upper support deck 108, down through the opening 134 in the intermediate level 132 defined by the intermediate support deck 112 and, ultimately, down to the lower level 122 proximate the rear end 118 of the lower support deck 110.

Thus, the guide 150 may receive products 16 exiting through the access opening 60 in the container 14 and may guide the products 16 down proximate the rear end 118 of the lower support deck 110, thereby allowing the products 16 guided to the lower level 122 to ultimately move to the first product display area 126. Once the lower level 122 of the frame 100 has been filled with products 16 such that the opening 134 in the intermediate level 132 is bridged by a product 16′ (FIG. 7), the guide 150 may guide the products 16 down proximate the rear end 130 of the intermediate support deck 112, thereby allowing the products 16 guided to the intermediate level 132 to ultimately move to the second product display area 138.

The catch element 102 may be positioned between the front end 140 and the rear end 142 of the upper support deck 108. For example, the catch element 102 may be positioned proximate the rear end 142 of the upper support deck 108.

The catch element 102 may laterally extend between the side walls 104, 106 of the frame 100, and may longitudinally protrude generally towards the front end 116 of the frame 100 at an angle that is substantially parallel and planar to the upper support deck 108. The specific size and shape of the catch element 102 may depend on the size and shape of the initiation opening 34 in the container 14.

As shown in FIG. 5B, the catch element 102 may further protrude a distance D₁ that is long enough to ensure that the access panel 58 (FIG. 6) is capable of being separated before it is redirected by the channel 154 as discussed in more detail herein. The distance D₁ may generally be less than or equal to 0.25 inches, less than or equal to 0.5 inches, less than or equal to 0.75 inches, or less than or equal to 1.0 inch.

In an effort to minimize interference between the catch element 102 and the container 14 during loading, the extended distance D₁ may allow for an engagement of the catch element 102 with the initiation opening 34 in such a way that the force F (FIG. 2B) applied to the base wall 26 may partially separate a portion of the base wall 26 from the container 14 along the first and second weakening features 50, 54 to form the access panel 58 (FIG. 3). Furthermore, engagement of the catch element 102 with the initiation opening 34 when the container 14 is inserted into the frame 100 as described herein may result in engagement at a point that is sooner than engagement of other catch elements and initiation openings known in the art. Those skilled in the art will appreciate that the extended distance D₁ may prevent the access panel 58 from becoming crumpled and/or caught in the catch element 102 as the container 14 is inserted into the frame 100. This is due to the ability for the catch element 102 to interact with the container 14 in stages (i.e., as the container 14 generally longitudinally moves along the upper support deck 108, initial separation of the access panel 58 may occur prior to the redirection of the access panel 58 by the access panel guide element 143), thereby providing the access panel 58 ample room to move laterally through the entrance passage 156 before being diverted and/or redirected by the channel 154, as described in greater detail herein.

In an effort to minimize interference between the catch element 102 and the container 14 during loading, the catch element 102 may be substantially co-planar with the upper surface 152 of the upper support deck 108. However, those skilled in the art will appreciate that slight displacement and/or a slight angle of the catch element 102 relative to the upper surface 152 of the upper support deck 108 may encourage engagement of the initiation opening 34 in the container 14 by the catch element 102 during loading of the container 14 onto the dispenser 12.

While the catch element 102 is shown and described as a generally flat, laterally elongated and forwardly extending protrusion, those skilled in the art will appreciate that various alternative structures may be used as the disclosed catch element 102 without departing from the scope of the present disclosure. For example, suitable catch elements may include various hooks, protrusions, flanges, detents and the like sufficient to engage the initiation opening 34 in the container 14 and separate the access panel 58 from the base wall 26 of the container 14.

The upper support deck 108 may define a guide channel 154 positioned to guide the access panel 58 below the upper support deck 108 as the access panel 58 is separated from the container 14 by the catch element 102. The channel 154 may extend from an entrance passage 156 proximate the catch element 102, down below the catch element 102 and, ultimately, to an exit opening 158. The entrance passage 156 may extend along a passage axis P (FIG. 5B) that is generally parallel with the longitudinal axis L (FIG. 5B) of the upper support deck 108. The channel 154 may be curved (e.g., generally C-shaped) from the entrance passage 156 such that the entrance passage 156 opens toward the front end 116 of the frame 100 above the upper support deck 108 and the exit opening 158 opens toward the front end 116 of the frame 100 below the upper support deck. The channel 154 may laterally extend between the side walls 104, 106 of the frame 100, and may have a lateral width sufficient to allow the access panel 58 (FIG. 3) to pass therethrough.

The access panel guide element 143 may laterally extend between the right and left side walls 104, 106, and may include a front end 145 that longitudinally extends toward the front end 116 of the frame 100. Therefore, the access panel guide element 143 and the side walls 104, 106 may define the exit opening 158. The exit opening 158 may laterally extend between the side walls 104, 106 of the frame 100, and may have a lateral width sufficient to allow the access panel 58 (FIG. 3) to pass from the channel 154 therethrough.

The access panel guide element 143 may define the exit opening 158 positioned to further guide the access panel 58 below the upper support deck 108 as the access panel 58 is further separated from the container 14 by the catch element 102 and passes through the channel 154. While the access panel guide element 143 shown and described herein is a generally curved (e.g., C shaped), laterally elongated and forwardly extending protrusion, those skilled in the art will appreciate that various alternative structures may be used as the disclosed access panel guide element 143 without departing from the scope of the present disclosure. For example, the access panel guide element 143 may extend in such a way that it does not come into contact with products 16 moving along the intermediate support deck 112 as described in more detail herein.

Thus, the catch element 102 may engage the initiation opening 34 (FIG. 2B) in the container 14 and may separate the access panel 58 (FIG. 3) from the container 14 as the container 14 is moved horizontally along the upper support deck 108 toward the rear end 120 of the frame 100. The shape and position of the catch element 102 may be configured such that a portion of the catch element 102 extends through the initiation opening 34 (FIG. 2B) in the container 14, and extends further into a portion of the container.

Therefore, as the container 14 moves relative to the catch element 102, the product 16 may urge the rear edge 66 of the base wall 26 of the container 14 downward so that the rear edge 66 is properly caught by the catch element 102, which then may urge the base wall 26 of the container 14 through the entrance passage 156 thereby causing separation of the access panel 58 (FIG. 3) from the container 14 along the first and second weakening features 50, 54 (FIG. 2B) and, ultimately, the formation of the access opening 60 (FIG. 3) in the container 14. As the container 14 is urged further, the access panel 58 may continue to longitudinally extend through the entrance passage 156 until it reaches the curved portion of the channel 154. The curved shape of the channel 154 may direct the separated access panel 58 backwards (i.e., a U-turn) into the exit opening 158 defined by the access panel guide element 143 such that the separated access panel 58 does not interact with products 16 moving along the intermediate support deck 112.

FIGS. 6 and 7 illustrate the container 14 being loaded onto the dispenser 12 such that the catch element 102 of the dispenser 12 engages and opens the container 14, thereby releasing the products 16 initially housed in the container 14 to the dispenser 12. Specifically, FIGS. 6 and 7 illustrate the container 14 being urged generally horizontally along the upper support deck 108 (i.e., along the longitudinal axis A of the upper support deck 108) toward the rear end 120 of the dispenser frame 100, thereby automatically opening the container 14 and dispensing the products 16 from the container 14 to the dispenser 12.

As shown in FIG. 6, as the initiation opening 34 (FIG. 2B) in the container 14 approximates the catch element 102 of the dispenser 12, the catch element 102 may pass through the initiation opening 34. With the catch element 102 extending through the initiation opening 34, the rear edge 66 of the base wall 26 of the container 14 may be directed downward through the entrance passage 156 of the channel 154.

As shown in FIG. 7, as the container 14 continues to longitudinally move along the upper support deck 108 toward the rear end 120 of the dispenser 12, a portion of the base wall 26 of the container 14 may pass through the entrance passage 156, and into the curved portion of the channel 154, thereby separating the access panel 58 from the base wall 26 of the container 14 to form the access opening 60 (FIG. 3). Due to the curved (roundabout chicane) shape of the channel 154, the separated access panel 58 may be directed backwards by the access panel guide element 143 and generally toward the front end 116 of the dispenser 12, thereby positioning a portion of the separated access panel 58 in the exit opening 158 above the intermediate level 132 of the frame 100 such that the separated access panel 58 does not interact with the products 16 supported on, and moving along, the intermediate support deck 112 of the frame 100.

With the container 14 fully loaded onto the dispenser 12, the access opening 60 (FIG. 3) formed in the container 14 may be aligned with the openings 134, 146 (FIG. 6) of the frame 80. Therefore, the force of gravity may urge the products 16 initially housed in the container 16 through the access opening 60 in the container 14, through the openings 134, 146 in the frame 80, and down to the lower support deck 110 and, ultimately, to the first product display area 126. Once the lower level 122 of the frame 100 has been filled with products 16 such that the opening 134 in the intermediate level 132 is bridged by a product 16′ (FIG. 7), the remaining products 16 exiting the container 14 through the access opening 60 may move onto the intermediate support deck 112 and, ultimately, to the second product display area 138.

As the products 16 move along the intermediate support deck 112, the products 16 do not interact with the access panel 58 of the container 14 due to the positioning of the access panel guide element 143. As shown in FIG. 7, the access panel 58 is prevented from brushing against the products 16 moving along the intermediate support deck 112, thereby prevent the products 16 from slowing down or getting caught and/or stuck as they travel along the intermediate support deck 112 toward the second product display area 138.

Thus, the catch element 102 and associated guide channel 154 may facilitate separation of the access panel 58 from the container 14 to form the access opening 60 in the container 14.

In doing so, the guide channel 154 may guide the separated access panel 58 such that it does not interfere with products 16 vertically exiting the container 14 through the access opening 60.

Although various aspects of the disclosed product dispensing system have been shown and described, modifications may occur to those skilled in the art upon reading the specification. The present application includes such modifications and is limited only by the scope of the claims.

What is claimed is:

1. A product dispensing system comprising:
a dispenser frame having a front end longitudinally opposed from a rear end, said dispenser frame comprising:
a first support deck extending at least partially between said front end and said rear end along a longitudinal axis, said first support deck defining a guide channel having an entrance passage extending along a passage axis, wherein said passage axis is generally parallel with said longitudinal axis; and
a second support deck positioned below said first support deck, said second support deck extending at least partially between said front end and said rear end, and defining a product display area proximate said front end; and
a catch element connected to said dispenser frame proximate said guide channel, wherein said entrance passage is at least partially defined by said catch element.

2. The product dispensing system of claim 1 wherein said entrance passage extends a distance along said passage axis, said distance being at least 0.25 inches.

3. The product dispensing system of claim 1 wherein said distance is at least 0.5 inches.

4. The product dispensing system of claim 1 wherein said distance is at least 0.75 inches.

5. The product dispensing system of claim 1 wherein said distance is at least 1 inch.

6. The product dispensing system of claim 1 wherein said catch element protrudes along an axis that is generally parallel with said longitudinal axis.

7. The product dispensing system of claim 1 wherein said guide channel further includes a curved portion connected to said entrance passage.

8. The product dispensing system of claim 1 wherein said first support deck defines a recessed drop zone, and wherein said entrance passage opens toward said recessed drop zone.

9. The product dispensing system of claim 8 wherein said catch element is connected to said dispenser frame proximate said recessed drop zone.

10. The product dispensing system of claim 8 further comprising a container positioned on said first support deck, said container initially housing a plurality of products therein.

11. The product dispensing system of claim 10 wherein a portion of said container is forced downward into said recessed drop zone under the weight of one or more products of said plurality of products.

12. The product dispensing system of claim 10 wherein a portion of said container extends through said entrance passage.

13. The product dispensing system of claim 1 wherein said dispenser frame further comprises a third support deck, and wherein said third support deck is positioned between said first support deck and said second support deck.

14. The product dispensing system of claim 1 wherein said first support deck defines an opening is said dispenser frame.

15. The product dispensing system of claim 14 further comprising a container supported on said first support deck, wherein said container defines an internal volume and an access opening into said internal volume.

16. The product dispensing system of claim 15 wherein said access opening is aligned with said opening defined by said first support deck.

17. A product dispensing system comprising:
a dispenser frame having a front end longitudinally opposed from a rear end, said dispenser frame comprising:
a first support deck extending at least partially between said front end and said rear end along a longitudinal axis, said first support deck defining an opening proximate said rear end and a guide channel having an entrance passage extending along a passage axis, wherein said passage axis is generally parallel with said longitudinal axis; and
a second support deck positioned below said first support deck, said second support deck extending at least partially between said front end and said rear end, and defining a product display area proximate said front end; and
a catch element connected to said dispenser frame proximate said guide channel, wherein said entrance passage is at least partially defined by said catch element; and
a container that defines an internal volume and an access opening into said internal volume, said container being positioned on said first support deck such that said access opening is aligned with said opening defined by said first support deck, wherein a portion of said container extends through said entrance passage.

18. The product dispensing system of claim 17 wherein said entrance passage extends a distance along said passage axis, said distance being at least 0.25 inches.

19. The product dispensing system of claim 17 wherein said catch element protrudes along an axis that is generally parallel with said longitudinal axis.

20. The product dispensing system of claim 17 wherein said first support deck defines a recessed drop zone, and wherein said entrance passage opens toward said recessed drop zone.
